(19) United States
(12) Patent Application Publication
(10) Pub. No.: US 2014/0313210 A1
(43) Pub. Date: Oct. 23, 2014

(54) EXTERNAL INDEPENDENT GRAPHICS DEVICE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventor: HUNG-CHI HUANG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/203,574

(22) Filed: Mar. 11, 2014

(30) Foreign Application Priority Data
Apr. 23, 2013 (TW) 102114470

(51) Int. Cl. G06T 1/20

(52) U.S. Cl. CPC G06T 1/20
USPC 345/520

(57) ABSTRACT

An exemplary external independent graphics device is capable of processing graphics data of a computer. The external independent graphics device includes a first thunderbolt port, a graphic processing unit, and a control unit. The external independent graphics device communicates with the computer via the first thunderbolt port. The control unit controls the first thunderbolt port to receive the graphics data from the computer, controls the graphic processing unit to process the received graphics data, and controls the first thunderbolt port to transmit the processed graphics data to the computer.

### BACKGROUND

1. Technical Field

The present disclosure relates to independent graphics devices, and particularly, to an external independent graphics device.

2. Description of Related Art

An advanced independent graphics device is often employed to satisfy an request for processing graphics data from a computer. The heat emitted by the advanced independent graphics device is great and the advanced independent graphics device is usually installed inside a computer, thus it is hard to dissipate the heat emitted by the independent graphics device, which may cause the computer to be damaged. Accordingly, there is a need for an external independent graphics device to resolve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an external independent graphics device, in accordance with an exemplary embodiment.

FIG. 2 is a schematic view showing a number of external independent graphics devices of FIG. 1 connected to each other.

FIG. 3 is a schematic view showing the external independent graphics device of FIG. 1 installed in a monitor.

### DETAILED DESCRIPTION

The embodiments of the present disclosure are now described in detail, with reference to the accompanying drawings.

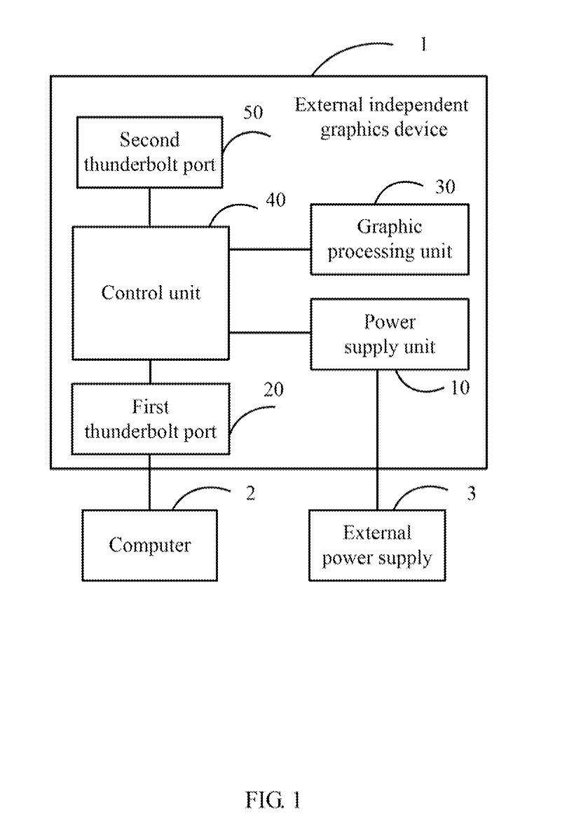

FIG. 1 shows an embodiment of an external independent graphics device 1.

The external independent graphics device 1 is an external peripheral device relative to a computer 2. The external independent graphics device 1 can connect with the computer 2 to process graphics data from the computer 2.

In the embodiment, the external independent graphics device 1 includes a power supply unit 10, a first thunderbolt port 20, a graphic processing unit 30, and a control unit 40. The power supply unit 10 obtains the power from an external power supply 3 and provides the obtained power to the control unit 40. The external independent graphics device 1 communicates with the computer 2 via the first thunderbolt port 20. The graphic processing unit 30 processes graphics data from the computer 2. The control unit 40 controls the first thunderbolt port 20 to receive the graphics data from the computer 2 and transmit the processed graphics data to the computer 2. The control unit 40 further controls the graphic processing unit 30 to process the received graphics data.

When needed, the control unit 40 controls the first thunderbolt port 20 to receive the graphics data from the computer 2, controls the graphic processing unit 30 to process the received graphics data, and further controls the first thunderbolt port 20 to transmit the processed graphics data to the computer 2. Thus, the external independent graphics device 1 can process the graphics data from the computer 2.

In the embodiment, the control unit 40 further enables the external independent graphics device 1 to process the graphics data from the computer 2 or disables the external independent graphics device 1 to process the graphics data from the computer 2 in response to user operation on the computer 2. In the embodiment, when the external independent graphics device 1 connects to the computer 2, the computer 2 provides a prompt signal to prompt the user to select the external independent graphics device 1 to process the graphics data from the computer 2. If the user chooses a first value, such as “yes”, the control unit 40 enables the graphic processing unit 30 of the external independent graphics device 1 to process the graphics data from the computer 2. If the user chooses a second value, such as “no”, the control unit 40 disables the graphic processing unit 30 of the external independent graphics device 1 to process the graphics data from the computer 2.

Thus, the control unit 40 can control the first thunderbolt port 20 and the graphic processing unit 30 to process the aforementioned operation when the control unit 40 enables the external independent graphics device 1 to employ the external independent graphics device 1 to process the graphics data from the computer 2, otherwise, the computer 2 itself processes the graphics data.

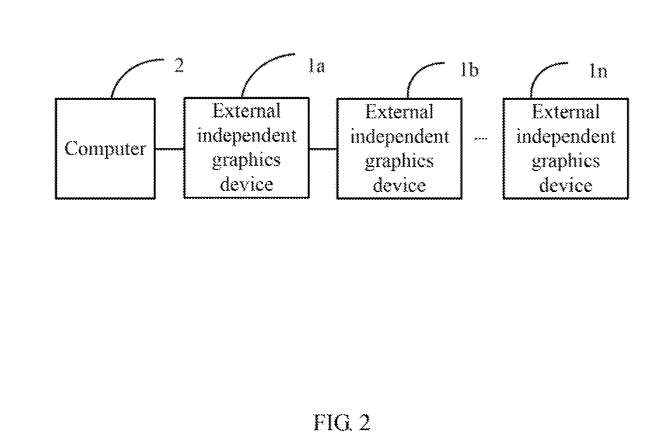

In the embodiment, the external independent graphics device 1 can further cooperate with another external independent graphics devices 1 to process the graphics data from the computer 2. The external independent graphics device 1 further includes a second thunderbolt port 50. The external independent graphics device 1 communicates with another external independent graphics device 1 via the second thunderbolt port 50. The control unit 40 of the external independent graphics device 1 communicates with the control unit 40 of another external independent graphics device 1 via the second thunderbolt port 50. In addition, controls the graphic processing unit 30 of the external independent graphics device 1 to cooperate with the graphic processing unit 30 of another external independent graphics device 1 via the second thunderbolt port 50 to process the graphics data from the computer 2. FIG. 2 shows external independent graphics devices 1a, 1b, . . . , 1n. The external independent graphics device 1 a is connected to the computer 2 via the first thunderbolt port 20, and is connected to the external independent graphics device 1b via the second thunderbolt port 50. In sequence, the external independent graphics device 1(n−1) is connected to the external independent graphics device In via the second thunderbolt port 50. In the embodiment, the number of the external independent graphics devices 1 connected to each other is less than or equal to six.

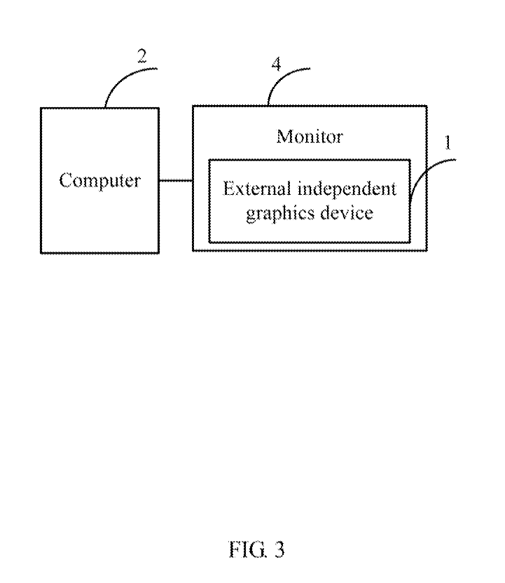

In the embodiment, the external independent graphics device 1 can be installed in a monitor 4 (as shown in FIG. 3). The monitor 4 can communicate with the computer 2 via the first thunderbolt port 20 and can communicate with another monitor 4 via the second thunderbolt port 50. The control unit 40 controls the first thunderbolt port 20, the graphic processing unit 30, and the second thunderbolt port 50 to execute the aforementioned operation, and further controls the monitor 4 to display the processed graphics data.

With that configuration, the external independent graphics device 1 is employed by the computer 2 to process the graphics data from the computer 2, accordingly, the heat emitted by the external independent graphics device 1 is not enclosed in a limited space, for example, a computer 2, then the heat is dissipated quickly. Moreover, the external independent graphics device 1 can cooperate with another external independent graphics device 1 to process the graphics data from the computer 2, thus the speed of processing the graphics data is also improved.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An external independent graphics device capable of processing graphics data from a computer, comprising:
a first thunderbolt port, the external independent graphics device communicating with the computer via the first thunderbolt port;
a graphic processing unit; and
a control unit configured to control the first thunderbolt port to receive the graphics data from the computer, control the graphic processing unit to process the received graphics data, and control the first thunderbolt port to transmit the processed graphics data to the computer.

2. The external independent graphics device as described in claim 1, further comprising a power supply unit, wherein the power supply unit is configured to obtain power from an external power supply and provide the obtained power to the control unit.

3. The external independent graphics device as described in claim 1, wherein the control unit is configured to enable or disable the external independent graphics device to process the graphics data from the computer in response to user operation on the computer.

4. The external independent graphics device as described in claim 1, further comprising a second thunderbolt port, wherein the control unit is configured to communicate with the control unit of another external independent graphics device via the second thunderbolt port, and is configured to control the graphic processing unit to cooperate with the graphic processing unit of another external independent graphics devices via the second thunderbolt port to process the graphics data from the computer.

5. The external independent graphics device as described in claim 1, wherein the external independent graphics device is installed in a monitor, the control unit is further configured to control the monitor to display the processed graphics data.
